(19) United States
(12) Patent Application Publication
(10) Pub. No.: US 2020/0383143 A1
(43) Pub. Date: Dec. 3, 2020

(54) METHODS AND APPARATUSES FOR ACCESSING CHANNEL IN WIRELESS POWERED COMMUNICATION NETWORK

(71) Applicant: RESEARCH & BUSINESS FOUNDATION SUNGKYUNKWAN UNIVERSITY, Suwon-si (KR)

(72) Inventors: Tae-Jin LEE, Suwon-si (KR); Kwan Young MOON, Suwon-si (KR); Arshad IQBAL, Suwon-si (KR)

(73) Assignee: RESEARCH & BUSINESS FOUNDATION SUNGKYUNKWAN UNIVERSITY, Suwon-si (KR)

(21) Appl. No.: 16/800,298

(22) Filed: Feb. 25, 2020

(30) Foreign Application Priority Data
May 31, 2019 (KR) 10-2019-0064753

(51) Int. Cl. H04W 74/08; H04W 88/10

(52) U.S. Cl. CPC H04W 74/0825; H04W 88/10

(57) ABSTRACT

Provided are a method and apparatus for accessing a channel in a wireless powered communication network. A channel access method in a wireless powered communication network includes performing a random backoff contention using a predetermined initial contention window value in order to access a channel in a wireless powered communication network, transmitting, to a relay hybrid access point, a request to send (RTS) packet to request data transmission or energy reception based on remaining energy when the random backoff contention is successful, and increasing the initial contention window value by a predetermined multiple when a collision occurs in the transmission of the transmitted RTS packet, and performs a random backoff contention again.

### CROSS-REFERENCE TO RELATED APPLICATIONS

This application claims priority to Korean Patent Application No. 10-2019-0064753 filed on May 31, 2019 in Korea, the entire contents of which are hereby incorporated by reference in their entirety.

### BACKGROUND

### 1. Technical Field

The present disclosure relates to a methods and apparatuses for accessing a channel in a wireless powered communication network.

### 2. Description of Related Art

The introduction and functions of IEEE 802.11 DCF are described. A distributed coordination function (DCF) is a medium access control (MAC) protocol used for nodes to avoid a collision in a wireless network environment. The DCF is divided into a method of performing channel contention using an exponential backoff method and then performing handshaking using a Request to Send (RTS) packet and a Clear to Send (CTS) packet prior to data transmission and a basic DCF method not using an RTS packet and a CTS packet.

FIG. 1 is a diagram illustrating an example of a carrier-sense multiple access with collision avoidance (CSMA/CA)-based DCF channel contention protocol operation.

An example of an operation of a CSMA/CA-based DCF channel contention protocol using an RTS/CTS packet after a backoff contention in a network environment configured with one access point (AP) and two nodes STA 1 and STA 2 is illustrated in FIG. 1. FIG. 1 illustrates a CSMA/CA-based DCF operation for nodes to exchange RTS/CTS packets before performing data transmission.

Each node selects a given random backoff value in contention window values and decreases the random backoff value until it reaches 0. Thereafter, the node transmits an RTS packet and determines the success or collision of channel access. If the node succeeds in the transmission of the RTS packet, it receives a CTS packet from the AP and transmits a data packet to the AP. Thereafter, the node receives an acknowledgement (ACK) packet, that is, an acknowledgement message for reliable end-to-end data transmission, from the A. If two or more nodes transmit RTS packets, the AP does not receive the RTS packets due to a collision between the RTS packets, and does not transmit a CTS packet. A node that has failed in the reception of the CTS packet doubles a contention window value CW, receives a new random backoff value within a corresponding range, and performs data transmission.

FIG. 2 is a diagram illustrating an example of a basic operation of a basic DCF channel contention protocol in which an RTS/CTS packet is not used after a backoff contention.

An example of a basic operation of the basic DCF channel contention protocol in which an RTS/CTS packet is not used after a backoff contention in a network environment configured with one AP and two nodes is illustrated in FIG. 2. FIG. 2 illustrates a basic DCF operation for nodes to not use an RTS/CTS packet before they perform data transmission.

In this case, after performing a backoff contention for channel contention, the node performs the transmission of a data packet using an RTS/CTS packet without a prior connection configuration with the AP. In the case of the basic DCF not using an RTS/CTS packet, when a collision occurs, data having a packet size relatively larger than an RTS packet is lost. Accordingly, a network throughput is reduced because a transmission time is increased. For example, as in FIG. 2, a node 1 (STA 1) and a node 2 (STA 2) successfully transmit data in the first and second attempts, respectively, using a backoff method. However, in subsequent data transmission, inefficient channel use occurs due to a collision between the data packets of the node 1 and the node 2.

Advantages and problems in the use of a relay in an energy harvesting network are described below.

In order to solve a power supply problem of devices having limited energy storages, an energy harvesting technology using RF energy is used a lot. However, the energy harvesting technology using RF energy has a limited range in the supply of power due to safety and health problems. As a method of solving such problems, a method of supplying energy to a node and relaying the data of the node to a base station (BS) is used. The use of the relay has advantages in that it can extend a power supply range and can reduce the health and safety problems because it use low transmission power. However, if the same channel is shared for data and energy transmission in a network environment configured with several nodes, a relay, and a BS, there is a problem in that the data transmission of the relay is delayed due to channel contention and use between the several devices. Accordingly, there is a need for a new method for guaranteeing the efficient energy reception of a node and the data transmission of a relay.

### SUMMARY

Exemplary embodiments according to the present disclosure provide a method and apparatus for accessing a channel in a wireless powered communication network, for the efficient data transmission and energy harvesting of a node in a relay-enabled wireless powered communication network (WPCN) environment configured with nodes, a relay hybrid access point (RHAP) and a base station (BS).

Exemplary embodiments of the present disclosure provide a method and apparatus for accessing a channel in a wireless powered communication network, which can supply energy to a node that requires the energy by selecting data transmission and energy reception based on a specific energy threshold and using a different RTS type based on the selection.

Exemplary embodiments of the present disclosure provide a method and apparatus for accessing a channel in a wireless powered communication network, which can guarantee a data transfer rate from an RHAP to a BS in a wireless powered communication network through different channel contentions in which different contention window values are used between a node and the RHAP.

According to one example embodiment of the present disclosure, there can be provided a channel access method performed by a node in a wireless powered communication network, including performing a random backoff contention using a predetermined initial contention window value in order to access a channel in a wireless powered communication network, transmitting, to a relay hybrid access point, a request to send (RTS) packet to request data transmission or energy reception based on the remaining energy when the random backoff contention is successful, and increasing the initial contention window value by a predetermined multiple when a collision occurs in the transmission of the transmitted RTS packet, and performs a random backoff contention again.

Performing the random backoff contention again may include performing the random backoff contention again using a contention window value exceeding a contention window value used by the relay hybrid access point.

Performing the random backoff contention again may include performing the random backoff contention again using a maximum contention window value when the contention window value increased by the predetermined multiple exceeds the maximum contention window value.

The method may further include increasing a retransmission count by a predetermined count when a collision occurs in the transmission of the transmitted RTS packet.

The method may further include terminating retransmission when the increased retransmission count exceeds a retransmission limit value and performing a channel contention for next data.

The method may further include receiving an acknowledgement packet as a response to the transmitted RTS packet, and transmitting data to a base station through the relay hybrid access point or receiving energy from the relay hybrid access point.

Meanwhile, according to another example embodiment of the present disclosure, there can be provided a channel access method performed by a relay hybrid access point in a wireless powered communication network, including receiving data from a node or transmitting energy to the node based on a type of request to send (RTS) packet received from the node, performing a random backoff contention using a contention window value for relay less than a contention window value used by the node in order to access a channel in a wireless powered communication network when data is received from the node, transmitting the RTS packet to a base station for data transmission when the random backoff contention is successful, and transmitting data to the base station when an acknowledgement packet is received as a response to the transmitted RTS packet.

Performing the random backoff contention may include performing the random backoff contention using a contention window value for relay less than a maximum contention window value used by the node.

The method may further include performing a random backoff contention again using a fixed contention window value for relay identically with a contention window value for relay used to select a previous random backoff value when a collision occurs in the transmission of the transmitted RTS packet.

The method may further include increasing a retransmission count by a predetermined count when a collision occurs in the transmission of the transmitted RTS packet.

The method may further include terminating retransmission when the increased retransmission count exceeds a retransmission limit value and performing a channel contention for next data.

Meanwhile, according to another example embodiment of the present disclosure, there can be provided a node in a wireless powered communication network, including a communication module communicating with a relay hybrid access point, a memory storing at least one program, and a processor connected to the communication module and the memory and configured to perform a data transmission operation or energy reception operation through the communication module. The processor may be configured to perform a random backoff contention using a predetermined initial contention window value in order to access a channel in a wireless powered communication network, transmit, to a relay hybrid access point, a request to send (RTS) packet to request data transmission or energy reception based on the remaining energy when the random backoff contention is successful, and increase the initial contention window value by a predetermined multiple when a collision occurs in the transmission of the transmitted RTS packet and perform a random backoff contention again, by executing the at least one program.

There can be provided a node in a wireless powered communication network in which the processor is configured to perform a random backoff contention again using a contention window value exceeding a contention window value used by the relay hybrid access point.

The processor may be configured to perform a random backoff contention again using a maximum contention window value when the contention window value increased by the predetermined multiple exceeds the maximum contention window value.

The processor may be configured to increase a retransmission count by a predetermined count when a collision occurs in the transmission of the transmitted RTS packet.

The processor may be configured to terminate retransmission when the increased retransmission count exceeds a retransmission limit value and perform a channel contention for next data.

The processor may be configured to receive an acknowledgement packet as a response to the transmitted RTS packet and to transmit data to a base station through the relay hybrid access point or receiving energy from the relay hybrid access point.

Meanwhile, according to another example embodiment of the present disclosure, there can be provided a relay hybrid access point in a wireless powered communication network, including a communication module communicating with a base station and a node, a memory storing at least one program, and a processor connected to the communication module and the memory and configured to perform a data transmission operation or energy reception operation through the communication module. The processor may be configured to receive data from a node or transmitting energy to the node based on a type of request to send (RTS) packet received from the node, perform a random backoff contention using a contention window value for relay less than a contention window value used by the node in order to access a channel in a wireless powered communication network when data is received from the node, transmit the RTS packet to a base station for data transmission when the random backoff contention is successful, and transmit data to the base station when an acknowledgement packet is received as a response to the transmitted RTS packet.

The processor may be configured to perform the random backoff contention using a contention window value for relay less than a maximum contention window value used by the node.

The processor may be configured to perform a random backoff contention again using a fixed contention window value for relay identically with a contention window value for relay used to select a previous random backoff value when a collision occurs in the transmission of the transmitted RTS packet.

The processor may be configured to increase a retransmission count by a predetermined count when a collision occurs in the transmission of the transmitted RTS packet.

The processor may be configured to terminate retransmission when the increased retransmission count exceeds a retransmission limit value and perform a channel contention for next data.

According to embodiments of the present disclosure, the data transmission and energy harvesting of a node can be efficiently performed in a relay-enabled wireless powered communication network (WPCN) environment configured with nodes, a relay hybrid access point (RHAP) and a base station (BS).

According to embodiments of the present disclosure, energy can be supplied to a node that requires the energy because data transmission and energy reception are selected based on a specific energy threshold and a different RTS type is used based on the selection.

According to embodiments of the present disclosure, a data transfer rate from an RHAP to a BS can be guaranteed in a wireless powered communication network through different channel contentions in which different contention window values are used between a node and the RHAP.

### BRIEF DESCRIPTION OF THE DRAWINGS

FIG. 1 is a diagram illustrating an example of a CSMA/CA-based DCF channel contention protocol operation.

FIG. 2 is a diagram illustrating an example of a basic operation of a basic DCF channel contention protocol in which an RTS/CTS packet is not used after a backoff contention.

FIG. 3 is a diagram for describing a wireless powered communication network environment to which a channel access method according to an embodiment of the present disclosure is applied.

FIG. 4 is a flowchart for illustrating a channel access method performed by a node in a wireless powered communication network according to an embodiment of the present disclosure.

FIGS. 5 and 6 are flowcharts for illustrating a detailed operation of a channel access method performed by a node in a wireless powered communication network according to an embodiment of the present disclosure.

FIG. 7 is a flowchart for illustrating a channel access method performed by a relay hybrid access point (RHAP) in a wireless powered communication network according to an embodiment of the present disclosure.

FIGS. 8 and 9 are flowcharts for illustrating a detailed operation of a channel access method performed by an RHAP according to an embodiment of the present disclosure.

FIG. 10 is a flowchart for illustrating a detailed operation of a channel access method performed by a base station according to an embodiment of the present disclosure.

FIG. 11 is a diagram for describing an example of an operation using a channel access method according to an embodiment of the present disclosure.

FIG. 12 is a block diagram for describing the configuration of a node in a wireless network according to an embodiment of the present disclosure.

FIG. 13 is a block diagram for describing the configuration of an RHAP in a wireless network according to an embodiment of the present disclosure.

FIG. 14 is a diagram illustrating parameters used for experiments for a performance comparison between a method according to an embodiment of the present disclosure and a conventional method.

FIG. 15 is a graph illustrating data throughput performance obtained by increasing the number of UEs from 5 to 50 in an embodiment of the present disclosure and a conventional method.

FIG. 16 is a graph illustrating energy efficiency performance obtained by increasing the number of UEs from 5 to 50 in an embodiment of the present disclosure and a conventional method.

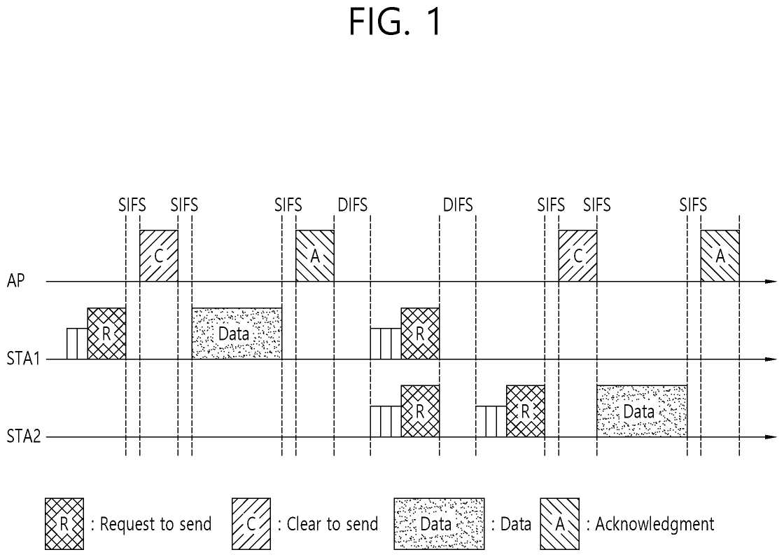

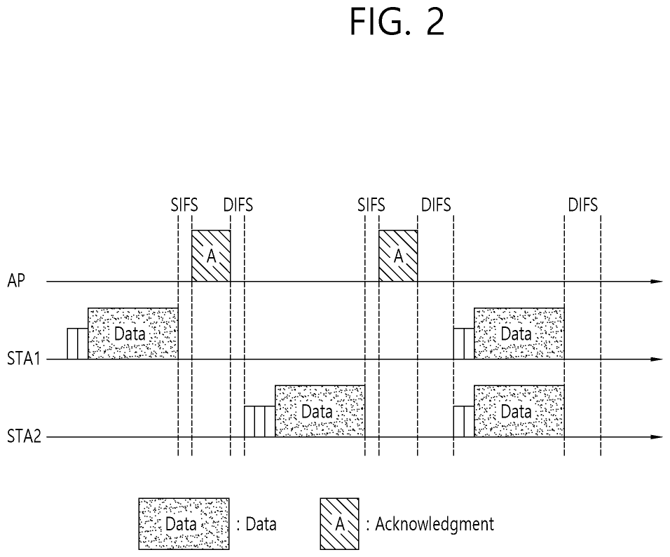

### DETAILED DESCRIPTION OF EXAMPLE EMBODIMENTS

The present disclosure may be changed in various ways and may have various embodiments, and specific embodiments are illustrated in the drawings and described in detail.

It is however to be understood that the present disclosure is not intended to be limited to the specific present disclosure and that the present disclosure includes all changes, equivalents and substitutions which fall within the spirit and technological scope of the present disclosure.

Terms, such as the first and the second, may be used to describe various elements, but the elements should not be restricted by the terms. The terms are used to only distinguish one element from the other element. For example, a first element may be named a second element without departing from the scope of rights of the present disclosure. Likewise, a second element may be named a first element. The term “and/or” includes a combination of a plurality of related and illustrated items or any one of a plurality of related and described items.

When it is said that one element is “connected” or “coupled” to the other element, it should be understood that one element may be directly connected or coupled” to the other element, but a third element may exist between the two elements. In contrast, when it is described that one element is “directly connected” or “directly coupled” to the other element, it should be understood that a third element does not exist between the two elements.

The terms used in this application are used to only describe specific embodiments and are not intended to restrict the present disclosure. An expression of the singular number should be construed as including an expression of the plural number unless clearly defined otherwise in the context. It is to be understood that in this application, a term, such as “include (or comprise)” or “have”, is intended to designate that a characteristic, number, step, operation, element or part which is described in the specification or a combination of them are present and does not exclude the existence or possible addition of one or more other characteristics, numbers, steps, operations, elements, parts or combinations of them in advance.

First, all terms used herein, including technical terms or scientific terms unless defined otherwise in the specification, have the same meanings as those commonly understood by a person having ordinary skill in the art to which the present disclosure pertains. Terms, such as those commonly used and defined in dictionaries, should be construed as having the same meanings as those in the context of a related technology, and should not be construed as having ideal or excessively formal meanings unless explicitly defined otherwise in the specification.

Hereinafter, preferred embodiments of the present disclosure are described in more detail with reference to the accompanying drawings. In describing the present disclosure, in order to help general understanding, the same reference numerals are used to denote the same elements throughout the drawings, and a redundant description of the same elements is omitted.

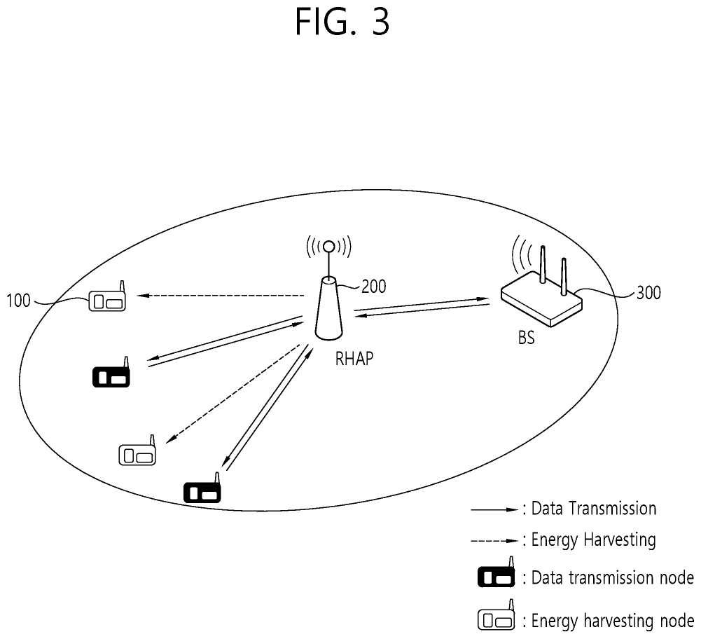

FIG. 3 is a diagram for describing a wireless powered communication network environment to which a channel access method according to an embodiment of the present disclosure is applied.

As illustrated in FIG. 3, a wireless powered communication network environment to which a channel access method according to an embodiment of the present disclosure is applied includes nodes 100, a relay hybrid access point 200 (RHAP) for relaying energy transmission to nodes and the data of the nodes 100 to a base station (BS) 300, and the BS 300. That is, a wireless powered communication network environment considered in an embodiment of the present disclosure includes multiple nodes in which data transmission and energy reception are performed and the RHAP 200 for relaying data, received from the nodes, to the BS 300 and supplying energy to nodes that require energy reception, as illustrated in FIG. 3.

In this case, some of the nodes 100 may operate as data transmission nodes, and other nodes thereof may operate as energy harvesting nodes. The data transmission node transmits data to the RHAP 200 after succeeding in channel contention. The energy harvesting node receives energy from the RHAP 200 after succeeding in channel contention.

Furthermore, a channel used for the data transmission and energy reception of the nodes and a channel through which the RHAP 200 relays the data of the nodes to the BS 300 use the same channel In this case, according to an embodiment of the present disclosure, a collision between the nodes 100 using the same channel and the RHAP 200 can be reduced because a different channel contention using a different contention window value is performed, and data transmission from the RHAP 200 to the BS 300 can be preferentially guaranteed compared to a channel used by the node 100.

A channel access method according to an embodiment of the present disclosure is divided into an operation of the node 100, an operation of the RHAP 200, and an operation of the BS 300 depending on operations of devices that configure a wireless powered communication network environment.

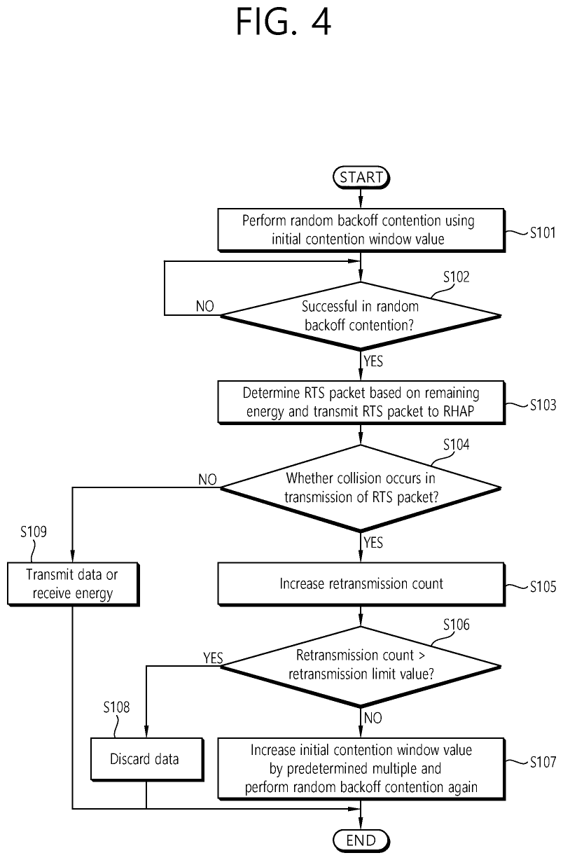

FIG. 4 is a flowchart for illustrating a channel access method performed by a node in a wireless powered communication network according to an embodiment of the present disclosure.

At step S101, the node 100 performs a random backoff contention using a predetermined initial contention window value.

At step S102, the node 100 checks whether it succeeds in the random backoff contention.

When the node 100 succeeds in the random backoff contention, at step S103, the node 100 determines a Request to Send (RTS) packet based on the remaining energy and transmits the RTS packet to the RHAP 200. If the node 100 fails in the random backoff contention, however, the node 100 performs step S102 of checking whether it succeeds in a random backoff contention.

At step S104, the node 100 checks whether a collision occurs in the transmission of the RTS packet.

If a collision occurs in the transmission of the RTS packet, at step S105, the node 100 increases a retransmission count by a predetermined count.

At step S106, the node 100 checks whether the increased retransmission count exceeds a retransmission limit value.

When the increased retransmission count does not exceed the retransmission limit value, at step S107, the node 100 increases an initial contention window value by a predetermined multiple (e.g., 2 multiple) and performs a random backoff contention again.

When the increased retransmission count exceeds the retransmission limit value, at step S108, the node 100 discards data and terminates the data transmission operation. Thereafter, the node 100 may check whether new data to be transmitted is present.

If a collision does not occur in the transmission of the RTS packet and a Clear to Send (CTS) packet is received, at step S109, the node 100 transmits data to the RHAP 200 or receives energy from the RHAP 200 depending on the type of CTS packet.

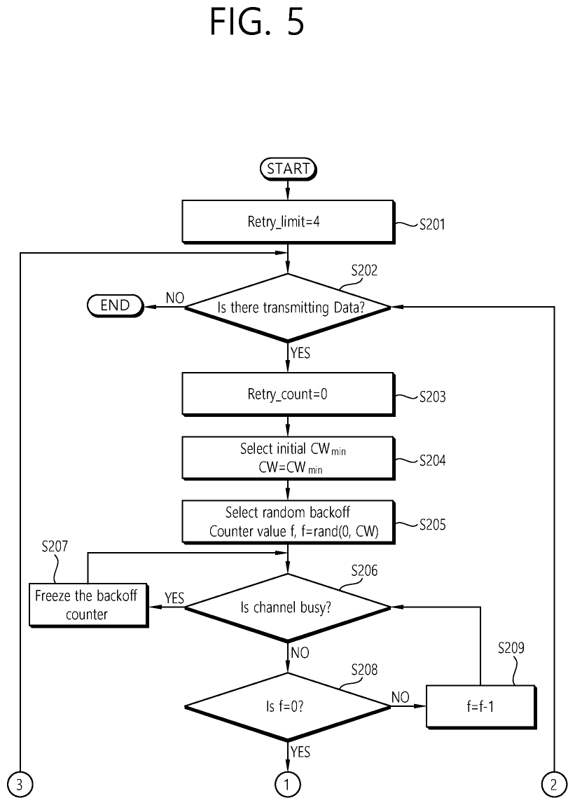

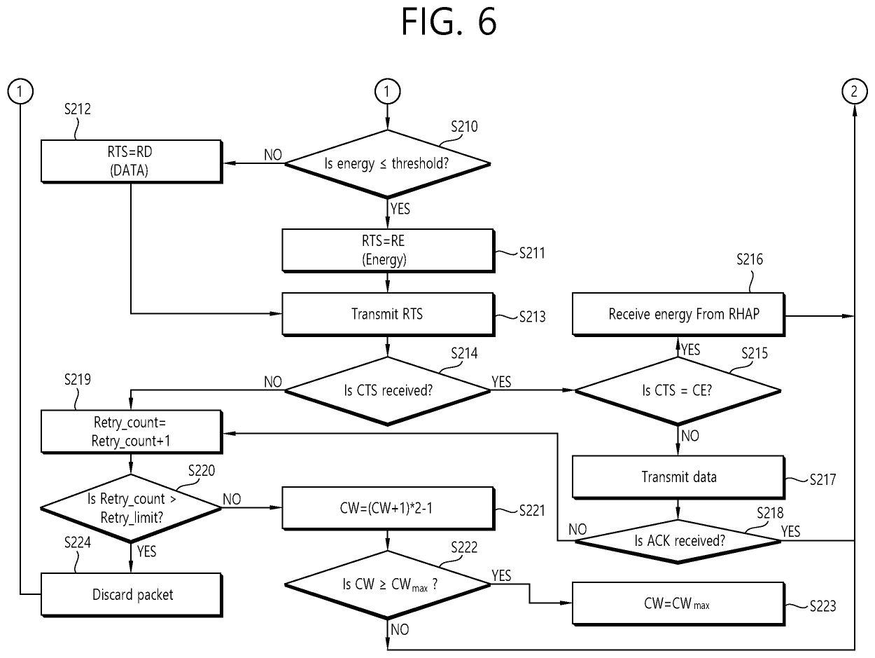

FIGS. 5 and 6 are flowcharts for illustrating a detailed operation of a channel access method performed by a node in a wireless powered communication network according to an embodiment of the present disclosure. Operations illustrated in FIGS. 5 and 6 are connected through \textcircled{1}, \textcircled{2} and \textcircled{3}.

A detailed operation of a channel access method performed by the node 100 may include a channel contention step, an RTS type determination step, a data transmission and energy reception step, and a new backoff value determination step. In the channel contention step, channel contention for a channel use is performed as in step S201 to step S209. The RTS type determination step is for an energy reception request and data transmission request based on the remaining energy when channel contention is successful as in step S210 to step S214. In the data transmission and energy reception step, a data transmission and energy reception operation using an RTS for Energy-harvesting (RE) packet or an RTS for Data-transmission (RD) packet, that is, a selected RTS type, as in step S215 to step S218. In the new backoff value determination step, a new backoff value is determined when a collision occurs in an RE/RD packet as in step S219 to step S224. Hereinafter, a detailed operation of a channel access method performed by the node 100 is described.

First, the channel contention step for the channel use of the node 100 is described. The node 100 that has data to be transmitted or that requires energy reception performs a DCF-based random backoff contention in order to use a channel before it transmits an RTS packet.

At step S201, the node 100 sets a retransmission limit value (Retry_limit) to 4. In this case, the retransmission limit value (Retry_limit) is not limited to a specific value.

At step S202, the node 100 checks whether data to be transmitted is present.

If data to be transmitted is present, at step S203, the node 100 sets a retransmission count (Retry_count) to 0.

The node 100 performs DCF-based the random backoff contention in order to use a channel before it transmits an RTS packet.

At step S204, the node 100 sets an initial contention window as a minimum contention window value like CW=CWₘᵢₙ (wherein CW is a contention window, and CWₘᵢₙ is a minimum contention window value). The node 100 that first participates in contention uses an initial contention window value.

At step S205, the node 100 selects a given random backoff counter value (f) within the range of the set contention window value like f=rand(0, CW). Thereafter, the node 100 performs a random backoff contention using the selected backoff counter value.

At step S206, the node 100 checks whether a channel is busy.

When the channel is busy, at step S207, the node 100 freezes the backoff counter value (f) and performs step S206 again.

When the channel is not busy, at step S208, the node 100 checks whether the backoff counter value (f) is 0.

When the backoff counter value (f) is not 0, at step S209, the node 100 decreases the backoff counter value (f) by 1.

Next, the RTS type determination step of the node 100 that has succeeded in channel contention is described.

At step S210, the node 100 checks whether the amount of remaining energy is a threshold or less.

When the amount of remaining energy is the threshold or less, at step S211, the node 100 determines the type of RTS packet as an RTS for Energy-harvesting (RE) packet that requests energy reception.

If the amount of remaining energy exceeds the threshold, however, at step S212, the node 100 determines the type of RTS packet as an RTS for Data-transmission (RD) packet that requests data transmission.

At step S213, the node 100 transmits, to the RHAP 200, an RTS packet corresponding to the determined type of the RTS packet. As described above, the node 100 that has succeeded in a backoff contention determines whether to transmit an RD packet for data transmission or an RE packet for energy reception based on the amount of remaining energy of the node 100. In this case, in a criterion for determining the RTS type, a node 100 having the remaining energy greater than a predetermined energy threshold selects the transmission of the RD packet, and a node 100 having the remaining energy not greater than the threshold selects the transmission of the RE packet.

The data transmission step of the node 100 using an RD packet and the energy reception step of the node 100 using an RE packet are described below.

At step S214, the node 100 checks whether a Clear to Send (CTS) packet is received from the RHAP 200.

When the CTS packet is received from the RHAP 200, at step S215, the node 100 confirms whether the type of received CTS packet is a CTS for Energy-harvesting (CE) packet.

When the type of received CTS packet is a CE packet, at step S216, the node 100 receives energy from the RHAP 200.

When the type of received CTS packet is not a CE packet, at step S217, the node 100 transmits data to the RHAP 200.

At step S218, the node 100 checks whether an acknowledgement (ACK) packet is received.

As described above, the node 100 that has selected the transmission of an RD packet after succeeding in contention transmits an RD packet to the RHAP 200. When the RD packet is successfully received by the RHAP 200, the node 100 receives a CTS for Data-transmission (CD) packet. Thereafter, the node 100 transmits data to the RHAP 200. When the data packet is successfully received by the RHAP 200, the node 100 may receive an ACK packet from the RHAP 200. Furthermore, while the node 100 that has succeeded in contention uses a corresponding channel, another node 100 and the RHAP 200 may monitor and update a transmission period in a network allocation vector (NAV).

Alternatively, the node 100 that has selected the transmission of an RE packet after succeeding in contention transmits an RE packet to the RHAP 200 unlike in the transmission of an RD packet. When the RE packet is successfully received by the RHAP 200, the node 100 receives a CTS for Energy-harvesting (CE) packet. Thereafter, the node 100 performs energy reception through an RF energy signal transmitted by the RHAP 200. In this case, another node 100 and the RHAP 200 monitor and update a transmission period in an NAV while the node 100 uses a corresponding channel

The determination step of a new backoff value according to an RD/RE packet collision is described below.

When a CTS packet is not received from the RHAP 200, at step S219, the node 100 increases the retransmission count by 1 like Retry_count=Retry_count+1.

At step S220, the node 100 checks whether the increased retransmission count exceeds the retransmission limit value (Retry_limit).

When the increased retransmission count is the retransmission limit value or less, at step S221, the node 100 doubles the contention window value like CW=(CW+1)*2−1.

At step S222, the node 100 checks whether the increased contention window value is a maximum contention window value CWₘₐₓ.

When the increased contention window value is the maximum contention window value (CWₘₐₓ) or more, at step S223, the node 100 sets the contention window value as the maximum contention window value CWₘₐₓ. When the increased contention window value is not the maximum contention window value (CWₘₐₓ) or more, the node 100 uses the increased contention window value.

When the increased retransmission count exceeds the retransmission limit value (Retry_limit), at step S224, the node 100 discards data and performs channel contention for next data.

As described above, if a collision occurs in the transmission of an RD or RE packet of the node 100 that has succeeded in channel contention, the node 100 doubles a corresponding contention window value whenever a collision occurs. Thereafter, the node 100 selects a new random backoff value within the increased contention window value and performs a backoff contention again. If the doubled contention window value is greater than a maximum contention window value CWₘₐₓ, the node 100 uses the doubled contention window value as the maximum contention window value CWₘₐₓ. The node 100 selects a new random backoff value within the maximum contention window value CWₘₐₓ and performs contention. Furthermore, a node in which a collision has occurred increases a retransmission count (Retry_count), that is, the retransmission number of times, whenever a collision occurs, and performs retransmission to a retransmission limit value (Retry limit) only, that is, a maximum retransmission number of times. If the retransmission count (Retry_count), that is, the retransmission number of times, exceeds the retransmission limit value (Retry limit), the node 100 discards data and performs channel contention for next data.

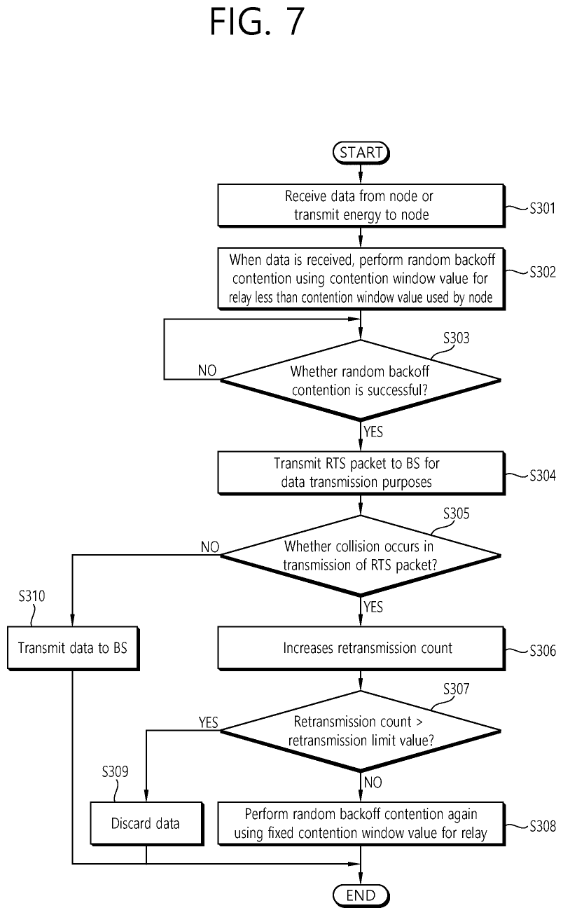

FIG. 7 is a flowchart for illustrating a channel access method performed by an RHAP in a wireless powered communication network according to an embodiment of the present disclosure.

At step S301, the RHAP 200 receives data from the node 100 or transmits energy to the node 100.

At step S302, when data is received, the RHAP 200 performs a random backoff contention using a contention window value for relay, which is less than a contention window value used by the node 100.

At step S303, the RHAP 200 checks whether the random backoff contention is successful.

When the random backoff contention is successful, at step S304, the RHAP 200 transmits an RTS packet to the BS 300 for data transmission purposes. When he RHAP 200 fails in the random backoff contention, however, the RHAP 200 performs step S302 of checking whether a random backoff contention is successful.

At step S305, the RHAP 200 checks whether a collision occurs in the transmission of the RTS packet.

If a collision occurs in the transmission of the RTS packet, at step S306, the RHAP 200 increases a retransmission count.

At step S307, the RHAP 200 checks whether the retransmission count exceeds a retransmission limit value.

When the retransmission count does not exceed the retransmission limit value, at step S308, the RHAP 200 performs a random backoff contention again using a fixed contention window value for relay. That is, the RHAP 200 does not increase the contention window value and uses the fixed contention window value for relay.

When the retransmission count exceeds the retransmission limit value, at step S309, the RHAP 200 discards data and terminates the data transmission operation.

If a collision does not occur in the transmission of the RTS packet, at step S310, the RHAP 200 transmits data to the BS 300.

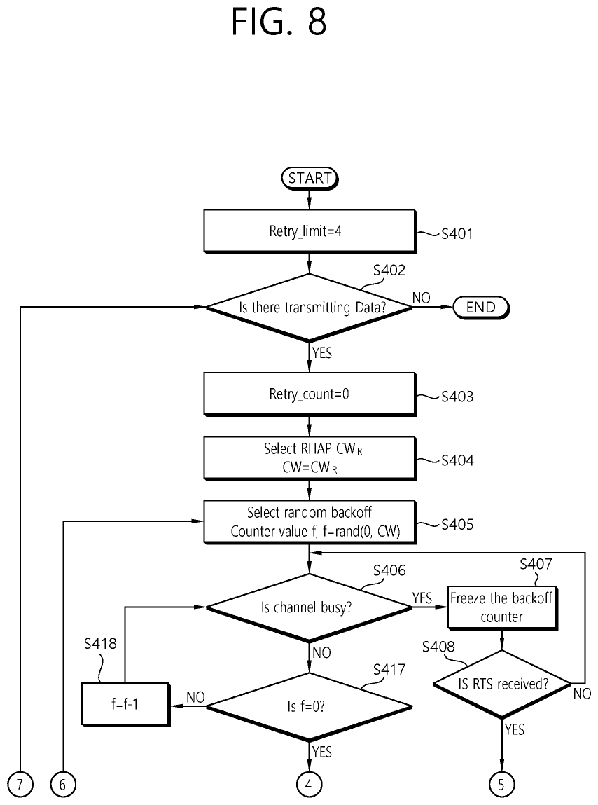

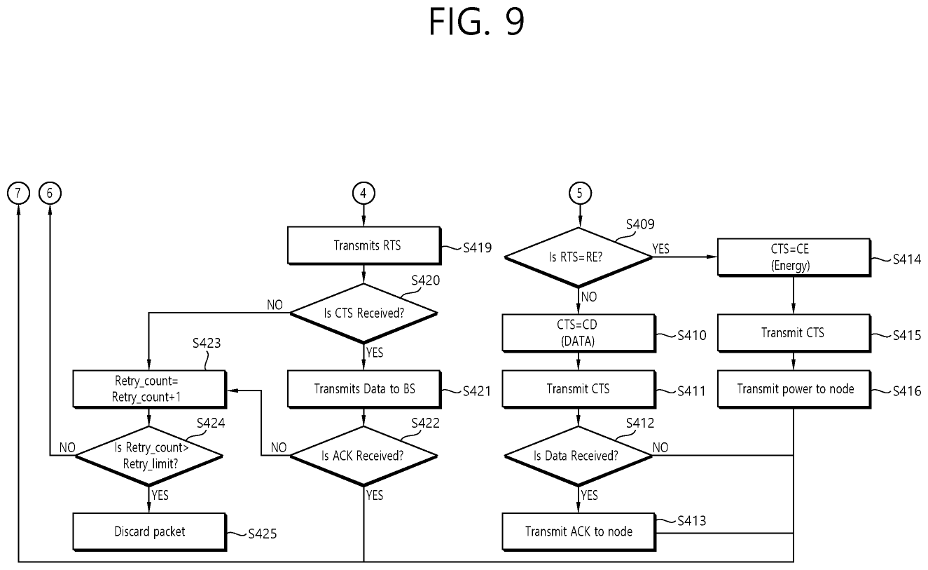

FIGS. 8 and 9 are flowcharts for illustrating a detailed operation of a channel access method performed by an RHAP according to an embodiment of the present disclosure. Operations illustrated in FIGS. 8 and 9 are connected through \textcircled{4}, \textcircled{5}, \textcircled{6} and \textcircled{7}.

A detailed operation of a channel access method performed by the RHAP 200 may include a data reception step, an energy transmission step, a channel contention and data transmission step, and a new backoff value determination step.

The data reception step includes an operation of performing data reception after an RD packet is received from the node 100 as in step S401 to step S413.

The energy transmission step includes an operation of performing energy transmission to the node 100 after an RE packet is received from the node 100 as in step S414 to step S416.

In the channel contention and data transmission step, as in step S417 to step S422, backoff channel contention and data transmission are performed for the channel use of the RHAP 200.

In the new backoff value determination step, as in step S423 to step S425, a new backoff value is determined when a collision occurs in the transmitted RTS packet.

First, the data reception step of the RHAP 200 that has received an RD packet from the node 100 is described.

At step S401, the RHAP 200 sets a retransmission limit value (Retry_limit) to 4. In this case, the retransmission limit value (Retry_limit) is not limited to a specific value.

At step S402, the RHAP 200 checks whether there is data to be transmitted.

When data to be transmitted is present, at step S403, the RHAP 200 sets a retransmission count (Retry_count) to 0.

At step S404, the RHAP 200 sets a contention window as a contention window value for relay like CW=CW_{R} (wherein CW is a contention window, and CW_{R} is a contention window value for relay).

At step S405, the RHAP 200 selects a given random backoff value (f) within the range of the set contention window value like f=rand(0, CW). Thereafter, the RHAP 200 performs a random backoff contention using the selected backoff value.

At step S406, the RHAP 200 checks whether a channel is busy.

When the channel is busy, at step S407, the RHAP 200 freezes the backoff counter value (f).

At step S408, the RHAP 200 checks whether an RTS packet is received from the node 100.

When the RTS packet is received from the node 100, at step S409, the RHAP 200 confirms whether the type or received RTS packet is an RTS for Energy-harvesting (RE) packet.

If the type of received RTS packet is not an RE packet, but is an RD packet, at step S410, the RHAP 200 determines the type of CTS packet as a CTS for Data-transmission (CD) packet to confirm data transmission.

At step S411, the RHAP 200 transmits the determined CTS packet to the node 100.

At step S412, the RHAP 200 checks whether data is received from the node 100.

When the data is received from the node 100, at step S413, the RHAP 200 transmits an acknowledgement (ACK) packet to the node 100.

As described above, if an RD packet transmitted to the RHAP 200 for data transmission purposes is successfully received by the RHAP 200 after the node 100 succeeds in channel contention, the RHAP 200 transmits a CD packet to the RHAP 200. Thereafter, if the data is successfully received from the node 100, the RHAP 200 notifies the node 100 that the data transmission has been completed by transmitting an ACK packet.

If the type of received RTS packet is an RE packet, at step S414, the RHAP 200 determines the type of CTS packet as a CTS for Energy-harvesting (CE) packet to confirm energy reception.

At step S415, the RHAP 200 transmits the determined CTS packet to the node 100.

At step S416, the RHAP 200 transmits energy to the node 100.

As described above, if an RE packet transmitted to the RHAP 200 for energy reception purposes is successfully received by the RHAP 200 after the node 100 succeeds in channel contention, the RHAP 200 transmits a CE packet. Thereafter, after a lapse of an SIFS, the RHAP 200 supplies an RF energy signal to the node 100, so the energy reception of the node 100 is performed.

When the channel is not busy, at step S417, the RHAP 200 checks whether a backoff counter value (f) is 0.

When the backoff counter value (f) is not 0, at step S418, the RHAP 200 decreases the backoff counter value (f) by 1.

When the backoff counter value (f) is 0, at step S419, the RHAP 200 transmits an RTS packet to the BS 300.

At step S420, the RHAP 200 checks whether a CTS packet is received from the BS 300.

When the CTS packet is received from the BS 300, at step S421, the RHAP 200 transmits data to the BS 300.

At step S422, the RHAP 200 checks whether an acknowledgement (ACK) packet is received from the BS 300.

As described above, the RHAP 200 having data to be transmitted uses a channel contention method different from that of the node 100 in order to use a channel before it transmits an RTS packet. In order to assign higher priority to a channel use for the data transmission of the RHAP 200, the RHAP 200 provides a fixed contention window value for relay CW_{R}, which is smaller than a maximum contention window value used by the node 100. The RHAP 200 uses a fixed contention window value for relay CW_{R}, which is smaller than a maximum contention window value used by the node 100, in order to perform a backoff contention, and selects a given random value within the range of the contention window value for relay CW_{R}. The RHAP 200 performs a backoff contention using the selected backoff value. The RHAP 200 that has succeed in the backoff contention transmits an RTS packet to the BS 300 for data transmission purposes, and receives a CTS packet if the RTS packet is successfully received by the BS 300. Thereafter, the RHAP 200 transmits data to the BS 300. If the data packet is successfully received by the BS 300, an ACK packet is received from the BS 300.

If an acknowledgement (ACK) packet is not received from the BS 300, at step S423, the RHAP 200 increases the retransmission count by 1 like Retry_count=Retry_count+1.

At step S424, the RHAP 200 checks whether the increased retransmission count exceeds the retransmission limit value (Retry_limit).

When the increased retransmission count exceeds the retransmission limit value (Retry_limit), at step S425, the RHAP 200 discards data and performs channel contention for next data.

If the increased retransmission count does not exceed the retransmission limit value (Retry_limit), at step S425, the RHAP 200 performs the process again from step S405.

As described above, if a collision occurs in the transmission of the RTS packet of the RHAP 200 that has succeeded in channel contention, the RHAP 200 selects a new random backoff value using a contention window value CW_{R} used to select a previous backoff value without any change, and performs a backoff contention again. Furthermore, the RHAP 200 having a collision increases a retransmission count (Retry_count), that is, the retransmission number of times, whenever a collision occurs, and performs retransmission to a retransmission limit value (Retry limit) only, that is, a maximum retransmission number of times. If the retransmission count (Retry_count), that is, the retransmission number of times, exceeds the retransmission limit value (Retry limit), the RHAP 200 discards data and performs channel contention for next data.

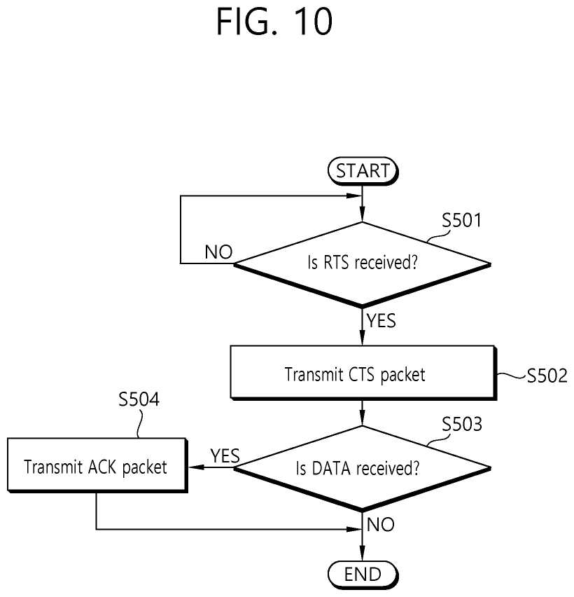

FIG. 10 is a flowchart for illustrating a detailed operation of a channel access method performed by a base station (BS) according to an embodiment of the present disclosure.

As illustrated in FIG. 10, at step S501, the BS 300 checks whether an RTS packet is received from the RHAP 200.

When the RTS packet is received from the RHAP 200, at step S502, the BS 300 transmits a CTS packet to the RHAP 200.

At step S503, the BS 300 checks whether data is received from the RHAP 200.

When the data is received from the RHAP 200, at step S504, the BS 300 transmits an ACK packet to the RHAP 200.

As described above, if an RTS packet transmitted to the BS 300 for data transmission purposes is successfully received by the BS 300 after the RHAP 200 succeeds in channel contention, the BS 300 transmits a CTS packet. Thereafter, if data is successfully received from the RHAP 200, the BS 300 notifies the RHAP 200 that data transmission has been completed by transmitting an ACK packet.

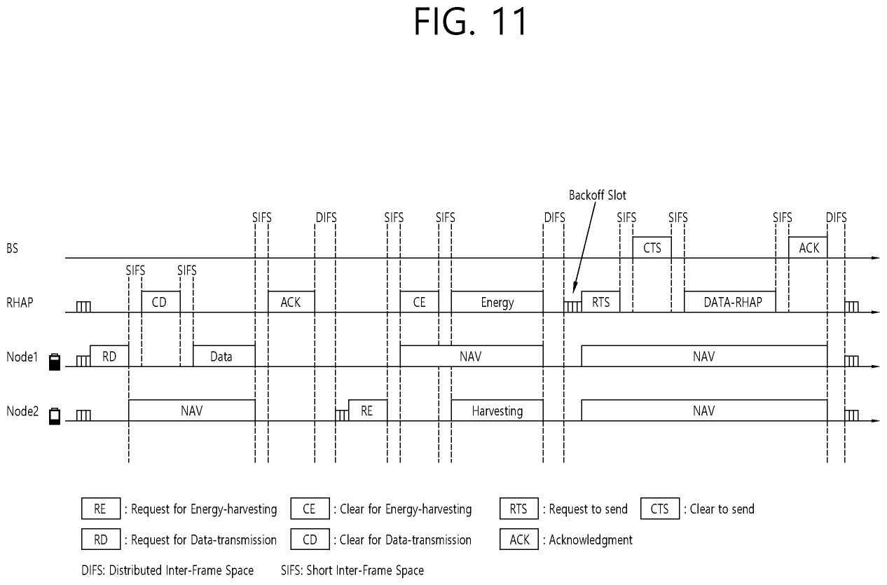

FIG. 11 is a diagram for describing an example of an operation using a channel access method according to an embodiment of the present disclosure.

Nodes Node 1 and Node 2 and the RHAP 200 perform a backoff contention for channel access. The node 100 1 (Node 1) that has succeeded in the backoff contention selects the transmission of an RD packet for data transmission because it has the remaining energy greater than a predetermined energy threshold. The RHAP 200 that has received the RD packet responds to the reception of the RD packet by transmitting a CD packet to the node 100 1. The node 100 1 transmits data to the RHAP 200. The RHAP 200 that has received the data performs ACK, indicating that the data transmission has been completed, by transmitting an ACK packet to the node 100 1. After a lapse of a DCF interframe space (DIFS) time, the node 100 1 that has received the ACK packet selects a random backoff value based on a contention window value used for next channel contention.

The node 100 2 (Node 2) to which channel use has been assigned in next channel contention selects the transmission of an RE packet for energy reception because it has the amount of remaining not greater than the predetermined energy threshold. The RHAP 200 that has received the RE packet transmits a CE packet to the node 100 2. After a lapse of an SIFS time, the RHAP 200 transmits energy to the node 100 2. Furthermore, the node 100 2 selects a random backoff value based on a contention window value used for a next random backoff contention.

The RHAP 200 that has succeeded in third channel contention transmits an RTS packet to the BS 300 in order to relay, to the BS 300, data received from the node 100. The BS 300 that has received the RTS packet responds to the reception of the RTS packet by transmitting a CTS packet to the RHAP 200. The RHAP 200 that has received the CTS packet transmits data to the BS 300. The BS 300 notifies the RHAP 200 that the data transmission has been completed by transmitting an ACK packet to the RHAP 200.

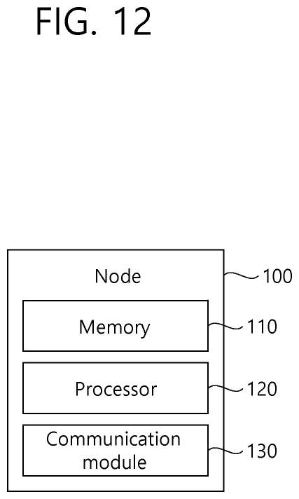

FIG. 12 is a block diagram for describing the configuration of a node in a wireless network according to an embodiment of the present disclosure.

As illustrated in FIG. 12, the node 100 according to an embodiment of the present disclosure includes a memory 110, a processor 120 and a communication module 130. However, all the illustrated elements are not essential elements. The node 100 may be implemented by elements more than the illustrated elements or the node 100 may be implemented by elements less than the illustrated elements.

Hereinafter, a detailed configuration and operation of each of the elements of the node 100 in FIG. 12 are described.

The communication module 130 communicates with the RHAP 200. The communication module 130 transmits data to a hybrid access point or receives energy from the hybrid access point.

The memory 110 stores at least one program.

The processor 120 is connected to the communication module 130 and the memory 110, and performs a data transmission operation or energy reception operation through the communication module 130.

By executing at least one program, the processor 120 performs a random backoff contention using a predetermined initial contention window value in order to access a channel in a wireless powered communication network, transmits, to the RHAP 200, an RTS packet to request data transmission or energy reception based on the remaining energy when the random backoff contention is successful, increases the initial contention window value by a predetermined multiple when a collision occurs in the transmission of the transmitted RTS packet, and performs a random backoff contention again.

According to various embodiments, the processor 120 may perform a random backoff contention again using a contention window value exceeding a contention window value used by the RHAP 200.

According to various embodiments, when a contention window value increased by a predetermined multiple exceeds a maximum contention window value, the processor 120 may perform a random backoff contention again using the maximum contention window value.

According to various embodiments, if a collision occurs in the transmission of a transmitted RTS packet, the processor 120 may increase a retransmission count by a predetermined count.

According to various embodiments, when an increased retransmission count exceeds a retransmission limit value, the processor 120 may terminate retransmission and perform a channel contention for next data.

According to various embodiments, the processor 120 may receive an ACK packet as a response to a transmitted RTS packet, and may transmit data to the BS 300 through the RHAP 200 or receive energy from the RHAP 200.

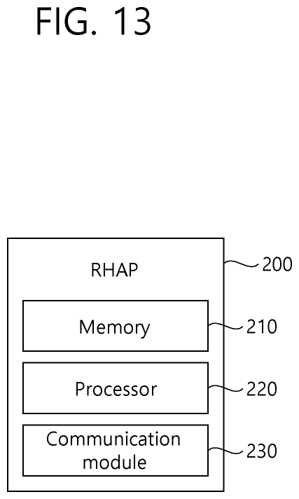

FIG. 13 is a block diagram for describing the configuration of an RHAP in a wireless network according to an embodiment of the present disclosure.

As illustrated in FIG. 13, the RHAP 200 according to an embodiment of the present disclosure includes a memory 210, a processor 220, and a communication module 230. However, all the illustrated elements are not essential elements. The RHAP 200 may be implemented by elements more than the illustrated elements or the RHAP 200 may be implemented by elements less than the illustrated elements.

Hereinafter, a detailed configuration and operation of each of the elements of the RHAP 200 in FIG. 13 are described.

The communication module 230 communicates with the BS 300 and the node 100. The communication module 230 transmits energy to the node 100 or relays data received from the node 100 by transmitting the data to the BS 300.

The memory 210 stores at least one program.

The processor 220 is connected to the communication module 230 and the memory 210, and performs an energy transmission operation or data transmission operation through the communication module 230.

By executing at least one program, the processor 220 receives data from the node 100 or transmits energy to the node 100 depending on the type of RTS packet received from the node 100, performs a random backoff contention using a contention window value for relay less than a contention window value used by the node 100 in order to access a channel in a wireless powered communication network when data is received from the node 100, transmits a RTS packet to the BS 300 for data transmission purposes when the random backoff contention is successful, and transmits data to the BS 300 when an acknowledgement packet is received as a response to the transmitted RTS packet.

According to various embodiments, the processor 220 may perform a random backoff contention using a contention window value for relay less than a maximum contention window value used by the node 100.

According to various embodiments, if a collision occurs in the transmission of a transmitted RTS packet, the processor 220 may perform a random backoff contention again using a fixed contention window value for relay identically with a contention window value for relay, which was used to select a previous random backoff value.

According to various embodiments, if a collision occurs in the transmission of a transmitted RTS packet, the processor 220 may increase a retransmission count by a predetermined count.

According to various embodiments, if an increased retransmission count exceeds a retransmission limit value, the processor 220 may terminate retransmission and performs a channel contention for next data.

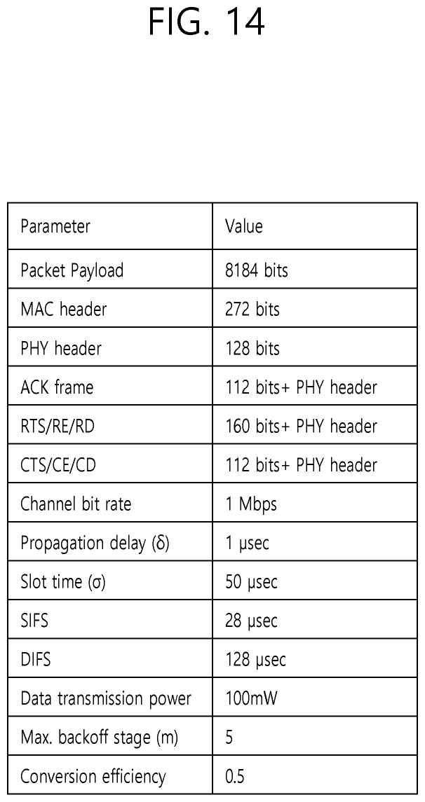

FIG. 14 is a diagram illustrating parameters used for experiments for a performance comparison between a method according to an embodiment of the present disclosure and a conventional method.

In these experiments, an embodiment of the present disclosure in which an RTS/CTS packet is used in a channel contention between the node 100 and the RHAP 200 and a conventional method not using an RTS/CTS packet in the channel contention are determined. Accordingly, a comparison was performed on the data throughput and energy efficiency of the node 100. Furthermore, the experiments were performed while each contention window value is changed in order to compare influences based on a contention window value used in the node 100 and a contention window value used in the RHAP 200. Table 1 illustrated in FIG. 14 is a table showing parameters used for the experiments. The amount of remaining energy of nodes was initially set to have a given amount of energy within a maximum battery energy range. Furthermore, in these experiments, simulations were performed assuming that the node 100 always has data to be transmitted to the RHAP 200.

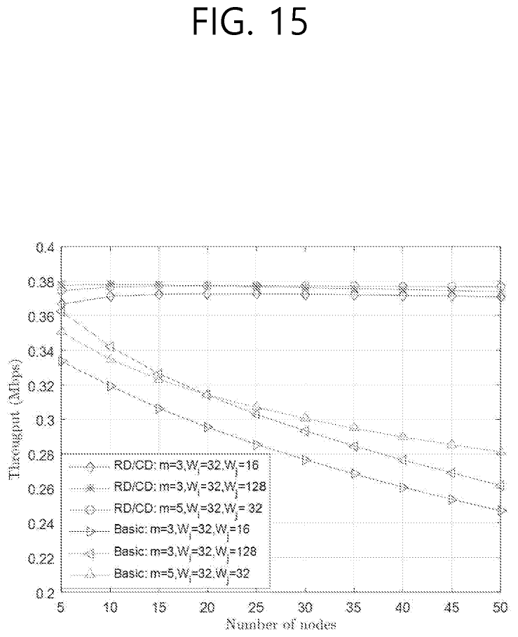

FIG. 15 is a graph illustrating data throughput performance obtained by increasing the number of UEs from 5 to 50 in an embodiment of the present disclosure and a conventional method.

FIG. 15 shows an effect of a data throughput according to an increase in the number of nodes 100 using different channel contention methods of the node 100 and the RHAP 200. The number of bits transmitted in a total simulation time may be different depending on the number of nodes 100 in a network. The number of nodes 100 that performs data transmission is changed depending on the number of received energy. Accordingly, a data throughput is different depending on energy harvesting. In the channel access method (RD/CD) using an RTS/CTS packet before data is transmitted according to an embodiment of the present disclosure, a collision occurs relatively less in the RTS packet than in a data packet. For this reason, it can be seen that the channel access method according to an embodiment of the present disclosure has better data throughput performance than the conventional method (Basic) that causes a total data packet loss. Furthermore, it can be seen that an increase in the contention window value of an RHAP reduces a collision probability with the node 100, but reduces the throughput by reducing a data transfer rate.

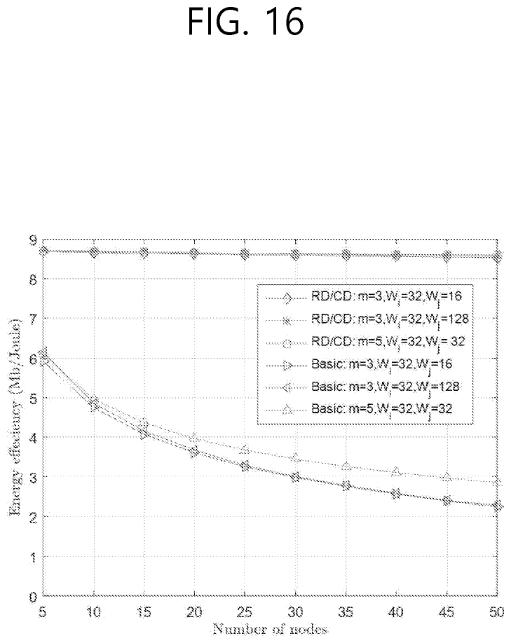

FIG. 16 is a graph illustrating energy efficiency performance obtained by increasing the number of UEs from 5 to 50 in an embodiment of the present disclosure and a conventional method.

FIG. 16 is a diagram showing energy efficiency according to a change in the number of nodes 100. In this case, simulations were performed while contention window values used to compare energy efficiency according to a contention window value used in the node 100 and energy efficiency according to a contention window value used in the RHAP 200 are changed like throughput performance Energy efficiency, that is, a performance index of the experiments, was set as the number of packets successfully transmitted compared to a total amount of energy used for data transmission. As the number of nodes 100 increases, a collision probability increases. An increase in the collision probability affects the success probability of the node 100 and decreases the number of received packets. Accordingly, it can be seen that energy efficiency is decreased as the number of nodes 100 increases. Furthermore, it can be seen that the channel access method (RD/CD) according to an embodiment of the present disclosure has higher energy efficiency than the conventional method (Basic). The reason for this is that the handshaking method according to an embodiment of the present disclosure consumes a relatively smaller amount of energy than the conventional method when a collision occurs because the handshaking method causes a relatively small packet loss when the collision occurs.

The channel access method in a wireless powered communication network according to embodiments of the present disclosure may be implemented in a computer-readable recording medium a computer-readable code form. The channel access method in a wireless powered communication network according to embodiments of the present disclosure may be implemented in the form of program instructions which may be executed through various computing means and may be written in a computer-readable recording medium.

As a non-transitory computer-readable storage medium including at least one program executable by a processor, there can be provided a non-transitory computer-readable storage medium, including the at least one program including instructions, which, when being executed by the processor, enable the processor to perform random backoff contention using a predetermined initial contention window value in order to access a channel in a wireless powered communication network, to transmit, to the RHAP, an RTS packet to request data transmission or energy reception based on the remaining energy when the random backoff contention is successful, to increase the initial contention window value by a predetermined multiple when a collision occurs in the transmission of the transmitted RTS packet, and to perform the random backoff contention again.

As a non-transitory computer-readable storage medium including at least one program executable by a processor, there can be provided a non-transitory computer-readable storage medium, including the at least one program including instructions, which, when being executed by the processor, enable the processor to receive data from a node or transmit energy to the node depending on the type of RTS packet received from the node, to perform a random backoff contention using a contention window value for relay less than a contention window value used by the node in order to access a channel in a wireless powered communication network when data is received from the node, to transmit an RTS packet to a BS for data transmission purposes when the random backoff contention is successful, and to transmit data to the BS when an acknowledgement packet is received as a response to the transmitted RTS packet.

The aforementioned method according to the present invention may be implemented in a computer-readable recording medium a computer-readable code form. The computer-readable recording medium includes all types of recording devices in which data capable of being decoded by a computer system is stored. For example, the computer-readable recording medium may include a read only memory (ROM), a random access memory (RAM), magnetic tapes, magnetic disks, a flash memory, and optical data storages. Furthermore, the computer-readable recording medium may be distributed to computer systems connected over a computer communication network, and may be stored and executed in the form of code readable in a distributed manner.

The present disclosure has been described above with reference to the accompanying drawings and embodiments, but it does not mean that the range of protection of the present disclosure is limited to the drawings or embodiments. Those skilled in the art may understand that the present disclosure may be modified and changed in various ways without departing from the spirit and scope of the present disclosure written in the claims.

Specifically, the illustrated characteristics may be executed in a digital electronic circuit, computer hardware, firmware or combinations of them. The characteristics may be executed in a computer program product implemented in a storage device within a machine-readable storage device, for example, for execution by a programmable processor. Furthermore, the characteristics may be executed by a programmable processor configured to execute the program of instructions for executing the functions of the aforementioned embodiments by operating on input data and generating output. The aforementioned characteristics may be executed within one or more computer programs that may be executed on a programmable system, including at least one programmable processor, at least one input device, and at least one output device combined in order to receive data and instructions from a data storage system and to send data and instructions to a data storage system. The computer program includes a set of instructions that may be directly or indirectly used in a computer in order to execute a specific operation on specific results. The computer program may be written in any one form of programming languages including complied or interpreted languages, and may be used in any form that is included as a module, a device, a subroutine, another unit suitable for being used in another computer environment, or a program that may be independently manipulated.

Proper processors for executing the program of the instructions may include, for example, both general-purpose and special-purpose micro processors, and a single processor or one of multi-processors of different types of computers. Furthermore, storage devices suitable for implementing computer program instructions and data for implementing the aforementioned characteristics may include all types of semiconductor memory devices such as EPROM, EEPROM, and flash memory devices, magnetic devices such as internal hard disks and removable disks, magneto-optical disks, and non-volatile memories including CD-ROM and DVD-ROM disks, for example. The processor and the memory may be integrated within application-specific integrated circuits (ASICs) or may be added by ASICs.

The present disclosure has been described based on a series of the function blocks, but the present disclosure is not limited to the aforementioned embodiments and accompanying drawings. It is evident to those skilled in the art to which the present disclosure pertains that the present disclosure may be substituted, modified, and changed in various ways without departing from the technical spirit of the present disclosure.

Combinations of the aforementioned embodiments are not limited to the aforementioned embodiment, and various forms of combinations may be provided depending on implementation and/or needs in addition to the aforementioned embodiments.

In the aforementioned embodiments, although the methods have been described based on the flowcharts in the form of a series of steps or blocks, the present disclosure is not limited to the sequence of the steps, and some of the steps may be performed in the sequence different from that of other steps or may be performed simultaneously with other steps. Furthermore, those skilled in the art will understand that the steps shown in the flowchart are not exclusive and the steps may include additional steps or that one or more steps in the flowchart may be deleted without affecting the scope of rights of the present disclosure.

The aforementioned embodiments include various aspects of examples. Although all kinds of possible combinations for representing the various aspects may not be described, those skilled in the art will understand that other possible combinations are possible. Accordingly, the present disclosure should be construed as including all other replacements, modifications, and changes which fall within the scope of the claims.

What is claimed is:

1. A channel access method performed by a node in a wireless powered communication network, the channel access method comprising:
performing a random backoff contention using a predetermined initial contention window value in order to access a channel in a wireless powered communication network;
transmitting, to a relay hybrid access point, a request to send (RTS) packet to request data transmission or energy reception based on remaining energy when the random backoff contention is successful; and
increasing the initial contention window value by a predetermined multiple when a collision occurs in the transmission of the transmitted RTS packet, and performs a random backoff contention again.

2. The channel access method of claim 1, wherein performing the random backoff contention again comprises performing the random backoff contention again using a contention window value exceeding a contention window value used by the relay hybrid access point.

3. The channel access method of claim 1, wherein performing the random backoff contention again comprises performing the random backoff contention again using a maximum contention window value when the contention window value increased by the predetermined multiple exceeds the maximum contention window value.

4. The channel access method of claim 1, further comprising increasing a retransmission count by a predetermined count when a collision occurs in the transmission of the transmitted RTS packet.

5. The channel access method of claim 4, further comprising terminating retransmission when the increased retransmission count exceeds a retransmission limit value and performing a channel contention for next data.

6. The channel access method of claim 1, further comprising:
receiving an acknowledgement packet as a response to the transmitted RTS packet; and
transmitting data to a base station through the relay hybrid access point or receiving energy from the relay hybrid access point.

7. A channel access method performed by a relay hybrid access point in a wireless powered communication network, the channel access method comprising:
receiving data from a node or transmitting energy to the node based on a type of request to send (RTS) packet received from the node;
performing a random backoff contention using a contention window value for relay less than a contention window value used by the node in order to access a channel in a wireless powered communication network when data is received from the node;
transmitting the RTS packet to a base station for data transmission when the random backoff contention is successful; and
transmitting data to the base station when an acknowledgement packet is received as a response to the transmitted RTS packet.

8. The channel access method of claim 7, wherein performing the random backoff contention comprises performing the random backoff contention using a contention window value for relay less than a maximum contention window value used by the node.

9. The channel access method of claim 7, further comprising performing a random backoff contention again using a fixed contention window value for relay identically with a contention window value for relay used to select a previous random backoff value when a collision occurs in the transmission of the transmitted RTS packet.

10. The channel access method of claim 7, further comprising increasing a retransmission count by a predetermined count when a collision occurs in the transmission of the transmitted RTS packet.

11. The channel access method of claim 10, further comprising terminating retransmission when the increased retransmission count exceeds a retransmission limit value and performing a channel contention for next data.

12. A node in a wireless powered communication network, the node comprising:
a communication module communicating with a relay hybrid access point;
a memory storing at least one program; and
a processor connected to the communication module and the memory and configured to perform a data transmission operation or energy reception operation through the communication module,
wherein the processor is configured to:
perform a random backoff contention using a predetermined initial contention window value in order to access a channel in a wireless powered communication network,
transmit, to a relay hybrid access point, a request to send (RTS) packet to request data transmission or energy reception based on remaining energy when the random backoff contention is successful, and
increase the initial contention window value by a predetermined multiple when a collision occurs in the transmission of the transmitted RTS packet and perform a random backoff contention again, by executing the at least one program.

13. The node of claim 12, wherein the processor is configured to perform a random backoff contention again using a contention window value exceeding a contention window value used by the relay hybrid access point.

14. The node of claim 12, wherein the processor is configured to perform a random backoff contention again using a maximum contention window value when the contention window value increased by the predetermined multiple exceeds the maximum contention window value.

15. The node of claim 12, wherein the processor is configured to increase a retransmission count by a predetermined count when a collision occurs in the transmission of the transmitted RTS packet.

16. The node of claim 15, wherein the processor is configured to terminate retransmission when the increased retransmission count exceeds a retransmission limit value and perform a channel contention for next data.

17. The node of claim 12, wherein the processor is configured to:
receive an acknowledgement packet as a response to the transmitted RTS packet, and
transmit data to a base station through the relay hybrid access point or receiving energy from the relay hybrid access point.

18. A relay hybrid access point in a wireless powered communication network, the relay hybrid access point comprising:
a communication module communicating with a base station and a node;
a memory storing at least one program; and
a processor connected to the communication module and the memory and configured to perform a data transmission operation or energy reception operation through the communication module,
wherein the processor is configured to:
receive data from a node or transmitting energy to the node based on a type of request to send (RTS) packet received from the node,
perform a random backoff contention using a contention window value for relay less than a contention window value used by the node in order to access a channel in a wireless powered communication network when data is received from the node,
transmit the RTS packet to a base station for data transmission when the random backoff contention is successful, and
transmit data to the base station when an acknowledgement packet is received as a response to the transmitted RTS packet.

19. The relay hybrid access point of claim 18, wherein the processor is configured to perform the random backoff contention using a contention window value for relay less than a maximum contention window value used by the node.

20. The relay hybrid access point of claim 18, wherein the processor is configured to perform a random backoff contention again using a fixed contention window value for relay identically with a contention window value for relay used to select a previous random backoff value when a collision occurs in the transmission of the transmitted RTS packet.
